(19) United States
(12) Patent Application Publication
(10) Pub. No.: US 2013/0258324 A1
(43) Pub. Date: Oct. 3, 2013

(54) SURFACE DEFECT DETECTING APPARATUS AND METHOD OF CONTROLLING THE SAME

(71) Applicants: Young Hun Lee, Gyunggi-do (KR); Joo Hong Kim, Gyunggi-do (KR); Suk Joon Lee, Gyunggi-do (KR)

(72) Inventors: Young Hun Lee, Gyunggi-do (KR); Joo Hong Kim, Gyunggi-do (KR); Suk Joon Lee, Gyunggi-do (KR)

(73) Assignee: SAMSUNG ELECTRO-MECHANICS CO., LTD., Gyunggi-do (KR)

(21) Appl. No.: 13/572,892

(22) Filed: Aug. 13, 2012

(30) Foreign Application Priority Data
Mar. 27, 2012 (KR) 10-2012-0031047

(51) Int. Cl. G01N 21/88

(52) U.S. Cl. 356/237.2

(57) ABSTRACT

Disclosed herein is a surface defect detecting apparatus including a stage unit having an upper surface on which a subject is disposed; at least one light source unit that is moved according to an examination condition and irradiates examination light onto a surface of the subject; an imaging unit that receives light emitted from the surface of the subject and captures an image of the surface of the subject; a controller that is connected to the at least one light source unit and the imaging unit, sets the examination condition, controls an overall operation, and detects a surface defect of the subject by using the image captured by the imaging unit; and a display unit displaying image information on the surface defect detected by the controller.

### CROSS REFERENCE TO RELATED APPLICATION

This application claims the benefit of Korean Patent Application No. 10-2012-0031047, filed on Mar. 27, 2012, entitled “Surface Defect Detecting Apparatus and Method Of Controlling the Same”, which is hereby incorporated by reference in its entirety into this application.

### BACKGROUND OF THE INVENTION

1. Technical Field

The present invention relates to a surface defect detecting apparatus and a method of controlling the same.

2. Description of the Related Art

As disclosed in Korean Patent Application No. 2006-0080306 (filed on Aug. 24, 2006), a conventional surface defect detecting apparatus includes a subject to be measured, a light source unit for illumination, and a detection camera for capturing an image of the subject and determines whether a surface defect of the subject exists or not by performing an image processing method on the captured image via the detection camera.

A method of examining a surface defect by using the light source unit of a surface defect detecting apparatus can be largely classified into bright field illumination and dark field illumination.

First, the bright field illumination is a method in which very bright illumination light is irradiated onto a surface of a subject in a structure including a light source unit arranged such that light is perpendicularly incident on a camera optical system and a filter allows the light of the light source unit to be perpendicularly incident on the surface of the subject. The bright field illumination is advantageous in that an image is barely distorted by shadows of impurities and a high quality image for easily detecting a surface defect can be obtained.

The dark field illumination is a method in which a light source unit emits illumination light onto a surface of a subject at a predetermined inclination with respect to a camera optical system. In the dark field illumination, the illumination is reflected off the surface of the subject again and does not longer exist. In this case, if the surface of the subject is in an optimal state (high quality surface roughness), a captured image looks black or dark. However, if fine impurities exist on the surface of the subject, only light that is reflected off edges of impurities again and is scattered is detected bright and looks outstanding.

However, in the surface defect examining method such as the bright field illumination and the dark field illumination, for example, when a surface of a diffractive optical element (DOE) having a uniform grating pattern is examined, background noise from the surface of the subject and noise due to a backlight effect as well as reflected examination light due to a surface defect are generated.

Thus, noise along with the reflected examination light is transmitted into an optical system, thereby reducing the contrast and resolution of an image.

### SUMMARY OF THE INVENTION

The present invention has been made in an effort to provide a surface defect detecting apparatus that may perform surface defect examination of a subject at a high resolution by shielding optical noise generated from a surface of the subject.

Further, the present invention has been made in an effort to provide a method of controlling a surface defect detecting apparatus, which may perform surface defect examination at a high resolution by shielding noise.

According to a first preferred embodiment of the present invention, there is provided a surface defect detecting apparatus including a stage unit having an upper surface on which a subject is disposed; at least one light source unit that is moved according to an examination condition and irradiates examination light onto a surface of the subject; an imaging unit that receives light emitted from the surface of the subject and captures an image of the surface of the subject; a controller that is connected to the at least one light source unit and the imaging unit, sets the examination condition, controls an overall operation, and detects a surface defect of the subject by using the image captured by the imaging unit; and a display unit displaying image information on the surface defect detected by the controller.

In the surface defect detecting apparatus, the at least one light source may include a lamp light source, and a collimator lens for converting light emitted from the lamp light source into linear light.

The surface defect detecting apparatus may further include at least one light shielding filter that is disposed on an optical path between the at least one light source unit and the subject and shields light at a wavelength range whereby optical noise is generated.

The surface defect detecting apparatus may further include an optical noise shielding optical filter disposed on an optical path between the imaging unit and the subject.

In the surface defect detecting apparatus, the at least one light source unit may include a mono color light source, and the light source may emit light of a mono color wavelength that is differently set from a wavelength of optical noise generated from the surface of the subject.

In the surface defect detecting apparatus, the light source may include a laser for emitting light of a mono color wavelength that is differently set from the optical noise generated from the surface of the subject; and a beam expander for enlarging the light emitted from the laser and irradiating the light onto the surface of the subject.

In the surface defect detecting apparatus, the examination condition may include, as a condition for converting optical noise generated from the surface of the subject into optical noise at the same frequency, a condition about an incident angle θ of the examination light, which is set so as to convert the optical noise into optical noise at the same frequency according to a grating interval ‘d’ of a uniform grating pattern of the subject and a diffraction order ‘m’.

In the surface defect detecting apparatus, the examination condition may include a rotation angle of the at least one light source unit with respect to the imaging unit.

According to a second preferred embodiment of the present invention, there is provided a method of controlling a surface defect detecting apparatus including at least one of light source unit irradiating examination light onto a surface of a subject disposed on an upper surface of a stage unit, and an imaging unit receiving light emitted from the surface of the subject and capturing an image of the subject of the subject, the method including setting an examination condition for examining a surface defect; obtaining image information on the surface of the subject by performing surface defect examination on the subject according to the examination condition; determining whether the obtained image information corresponds to image information by which the surface defect of the subject is capable of being detected; when it is determined that the obtained image information corresponds to defective image information by which a surface defect is not capable of being detected, resetting the examination condition; obtaining image information on the surface of the subject again by performing surface defect examination again on the subject according to the reset examination condition; determining again whether the image information that is obtained again corresponds to image information by which the surface defect of the subject is capable of being detected; and when it is determined that the image information that is obtained again corresponds to the image information by which the surface defect of the subject is capable of being detected, detecting information on the surface defect from the image information that is obtained again.

In the method of controlling a surface defect detecting apparatus, in the setting of the examination condition, the examination condition may include a condition for converting optical noise generated from the surface of the subject into optical noise at the same frequency and may include a condition about an incident angle θ of the examination light, which is set so as to convert the optical noise into optical noise at the same frequency according to a grating interval ‘d’ of a uniform grating pattern of the subject and a diffraction order ‘m’.

In the method of controlling a surface defect detecting apparatus, the incident angle may satisfy a relationship of n′ sin θ′−n sin θ=m(λ/d) (n′: refractive index of emitted-light region, θ′: emitting angle of emitted light, n: refractive index of irradiated light, θ: incident angle of irradiated light, m: diffraction order of emitted light, λ: wavelength of emitted light, d: grating interval of the subject).

In the method of controlling a surface defect detecting apparatus, the obtaining of the image information may further include shielding optical noise which is converted at the same frequency by using an optical noise shielding optical filter.

In the method of controlling a surface defect detecting apparatus, in the resetting of the examination condition, at least one of a diffraction order ‘m’, a wavelength of the examination light ‘λ’, and an incident angle θ of the examination light may be reset with respect to a grating interval ‘d’ of a uniform grating pattern of the subject.

In the method of controlling a surface defect detecting apparatus, the resetting of the examination condition may further include resetting a rotation angle of the at least one light source unit with respect to the imaging unit.

In the method of controlling a surface defect detecting apparatus, the detecting of the information on the surface defect may further include displaying information on a region where the surface defect of the subject is detected together with a number.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee.

The above and other objects, features and advantages of the present invention will be more clearly understood from the following detailed description taken in conjunction with the accompanying drawings, in which:

FIG. 1 is a front view of a surface defect detecting apparatus according to an embodiment of the present invention;

FIG. 2A is a diagram for describing a structure and examination principle of surface defect detecting apparatus according to an embodiment of the present invention;

FIG. 2B is a diagram for describing a structure and examination principle of surface defect detecting apparatus according to another embodiment of the present invention;

FIG. 2C is a diagram for describing a structure and examination principle of surface defect detecting apparatus according to another embodiment of the present invention;

FIG. 2D is a diagram for describing a structure and examination principle of surface defect detecting apparatus according to another embodiment of the present invention;

FIG. 3 is a flowchart of a method of controlling a surface defect detecting apparatus, according to an embodiment of the present invention;

FIG. 4 is a diagram for describing an operation of setting a diffraction order in a method of controlling a surface defect detecting apparatus, according to an embodiment of the present invention;

FIG. 5 is a diagram for describing information on a surface defect and an optical noise process in a method of controlling a surface defect detecting apparatus, according to an embodiment of the present invention;

FIG. 6 is a color diagram of optical colors of optical noise according to an examination condition in a method of controlling a surface defect detecting apparatus, according to an embodiment of the present invention;

FIGS. 7A and 7B are diagrams for describing a method of controlling a surface defect detecting apparatus according to an embodiment of the present invention; and

FIG. 8 is an image on which a surface defect is displayed in a method of controlling a surface defect detecting apparatus, according to an embodiment of the present invention.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

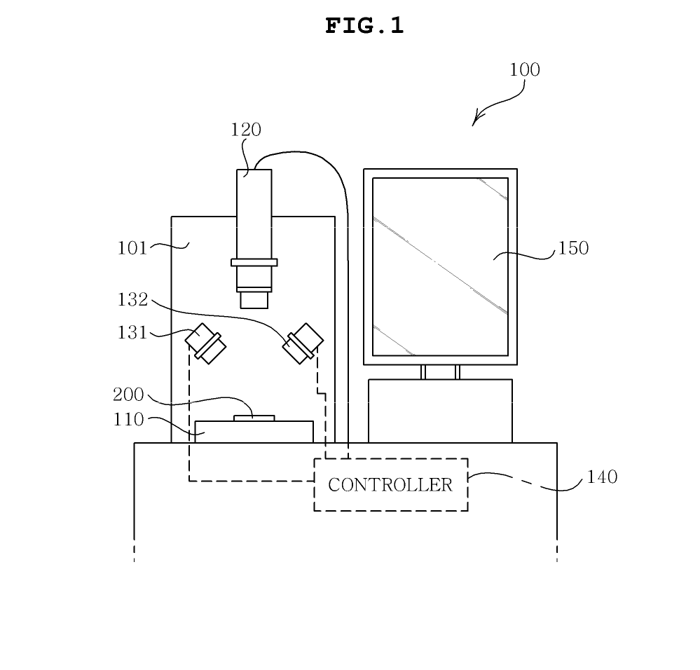

Hereinafter, preferred embodiments of the present invention will be described in detail with reference to the attached drawings. FIG. 1 is a front view of a surface defect detecting apparatus 100 according to an embodiment of the present invention.

The surface defect detecting apparatus 100 according to the present embodiment includes a stage unit 110 having an upper surface on which a subject 200 is disposed, at least one light source unit, that is, light source units 131 and 132 that are installed on one side or two opposite sides of a rear support plate 101, are moved according to an examination condition, and irradiates examination light onto a surface of the subject 200, an imaging unit 120 that is installed on the rear support plate 101, receives light emitted from the surface of the subject 200, and captures an image of the surface of the subject 200, a controller 140 that is connected to the light source units 131 and 132, the imaging unit 120, and the like, controls an overall operation of the surface defect detecting apparatus 100, and detects a surface defect based on the image captured by the imaging unit 120, and a display unit 150 for displaying image information on the surface defect detected by the controller 140. In this case, the subject 200 may correspond to an optical device having a uniform grating pattern, such as a complementary metal oxide silicon (CMOS) image sensor, a charge coupled device (CCD) image sensor, or the like.

The imaging unit 120 includes a light receiving lens, a polarization filter, and a CCD imaging device and is disposed on an upper portion of the rear support plate 101 so as to correspond to the subject 200 of the stage unit 110. The CCD imaging device of the imaging unit 120 may collectively capture an image of an entire surface of the subject 200.

The light source units 131 and 132 are installed on one side or two sides of the rear support plate 101 with respect to the stage unit 110 having the upper surface on which the subject 200 is disposed. In this case, the light source units 131 and 132 may be moved in order to irradiate light onto the subject 200 at a predetermined incident angle θ according to control information of the controller 140 based on the examination condition.

In FIG. 1, the light source units 131 and 132 are installed on two sides of the rear support plate 101 with respect to the stage unit 110. However, the present invention is not limited thereto. For example, the light source unit 131 may be installed on a left side only and may irradiate the examination light onto the surface of the subject 200 while rotating at a predetermined angle θ with respect to the imaging unit 120.

The controller 140 may control an overall operation of the surface defect detecting apparatus 100 according to the examination condition that is set in order to detect a surface defect of the subject 200 so as to irradiate the light of the light source units 131 and 132, which is incident on the subject 200, at a set incident angle and a rotation angle with respect to the imaging unit 120 by changing, for example, positions and diffraction orders of the light source units 131 and 132.

Then, the controller 140 determines whether the image information obtained from the imaging unit 120 corresponds to image information by which noise is capable of being shielded and a surface defect of the subject 200 is capable of being detected, according to a user command or by automation. According to the determination result, when it is determined that the image information obtained from the imaging unit 120 corresponds to the image information by which the surface defect is capable of being detected, the controller 140 automatically detects the surface defect from the image information.

In this case, the controller 140 may display information of the detected surface defect on the display unit 150, for example, may display defects such as impurities including dust or scratches having a convex or concave shape via the display unit 150.

The surface defect detecting apparatus 100 having the above-described structure may convert optical noise generated from the subject 200, such as diffraction light generated from a repeated pattern of the subject 200 into optical noise at the same frequency according to the set examination condition.

The surface defect detecting apparatus 100 may selectively include a shielding filter and an optical filter for shielding optical noise, for example, a band filter, a notch filter, and a dichroic filter and may shield the converted optical noise at the same frequency.

Alternatively, the surface defect detecting apparatus 100 may have a light source unit obtained by modifying the light source units 131 and 132. In this case, the light source unit irradiates light from which a wavelength range whereby optical noise is generated from the subject 200 is removed onto the subject 200, thereby originally preventing optical noise.

Accordingly, since the surface defect detecting apparatus 100 according to the present embodiment may shield generated optical noise by using the shielding filter and the optical filter for shielding optical noise or may originally prevent optical noise, the surface defect detecting apparatus 100 may detect only image information containing information on a surface defect of the subject 200 and may detect the surface defect of the subject 200 at a high resolution.

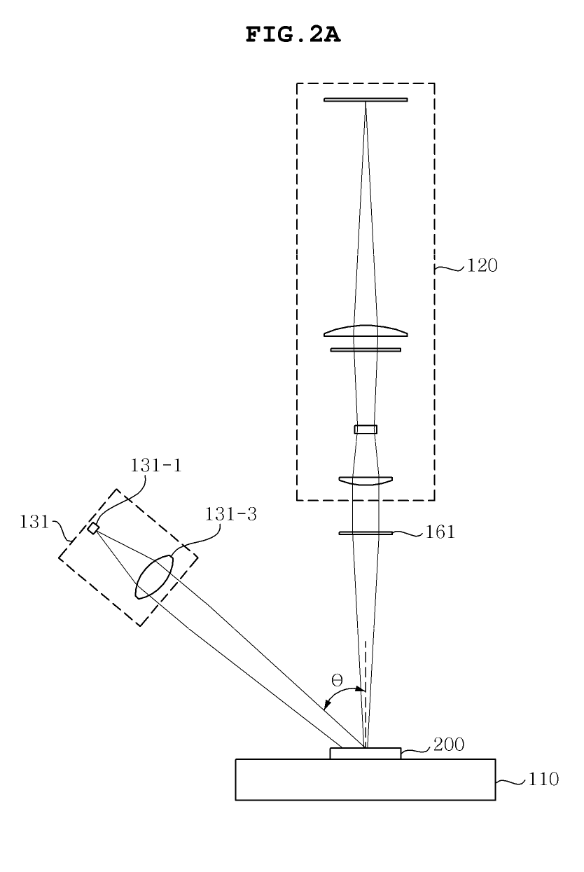

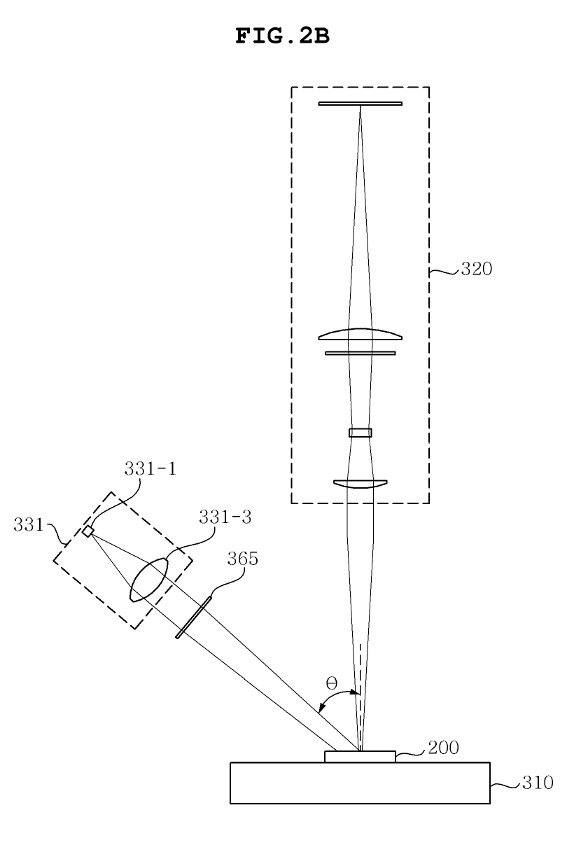

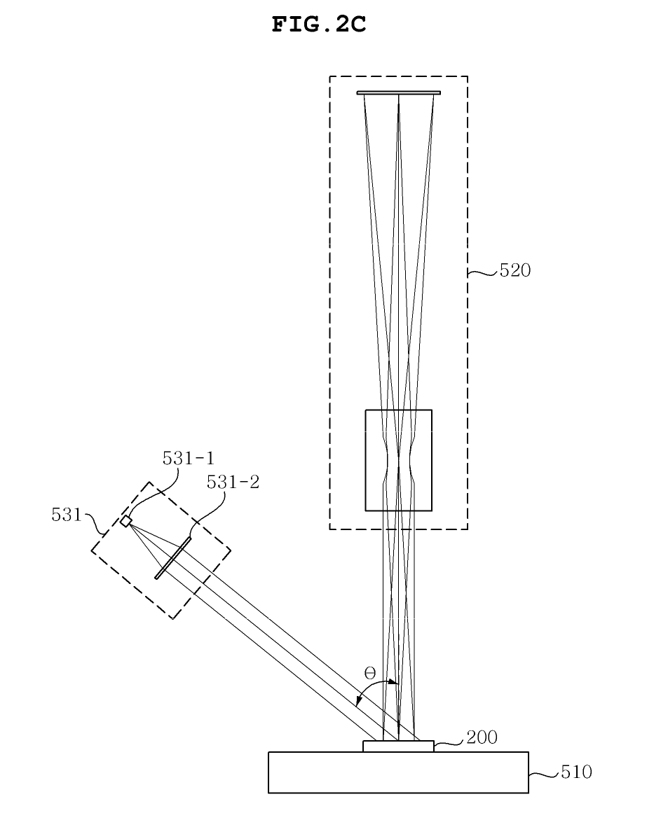

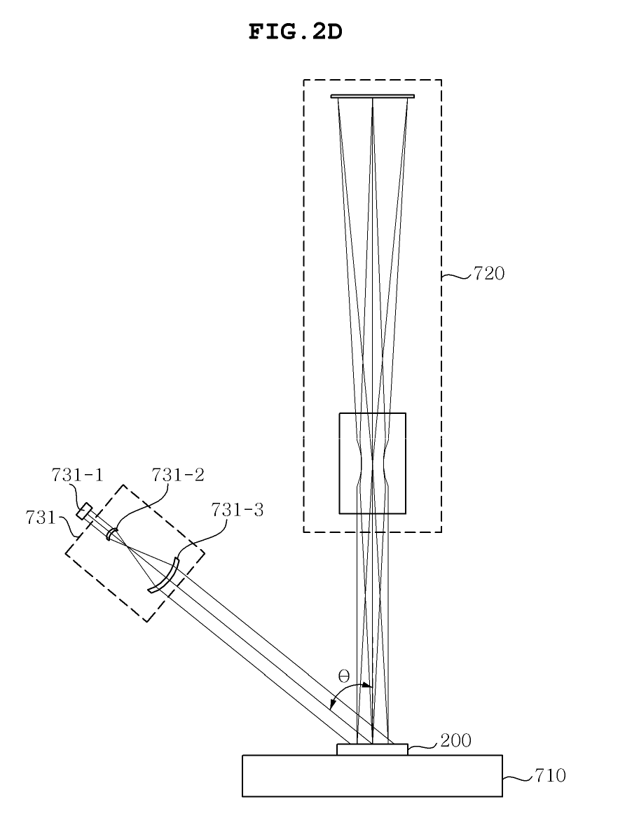

Hereinafter, structures and examination principles of surface defect detecting apparatuses according to embodiments of the present invention will be described with reference to FIGS. 2A through 2D. FIGS. 2A through 2D are diagrams for describing the structures and detection principles of surface defect detecting apparatuses according to various embodiments of the present invention.

The surface defect detecting apparatus of FIG. 2A may be configured such that an optical noise shielding optical filter 161 may be installed between the imaging unit 120 and the subject 200 and the optical noise shielding optical filter 161 may prevent optical noise having the same wavelength, which is generated from the subject 200, from being incident on the imaging unit 120.

In this case, a light source unit 131 shown in FIG. 2A may include a light source 131-1 such as a metal halide lamp, a mercury lamp, a halogen lamp, or the like, and a collimator lens 131-3 for changing light emitted from the light source 131-1 into linear light.

The light source unit 131 may irradiate the light emitted from the light source 131-1 onto the subject 200 at a predetermined incident angle θ according to control of the controller 140 such that optical noise that is to be generated from the subject 200 and to be incident on the imaging unit 120 may have the same wavelength. Of course, the light source unit 131 may irradiate the light emitted from the light source 131-1 onto the subject 200 at a predetermined rotation angle that is set with respect to the imaging unit 120.

Thus, since the optical noise of the same wavelength may be shielded by the optical noise shielding optical filter 161 before being incident on the imaging unit 120, the imaging unit 120 may detect only image information containing information on a surface defect of the subject 200 without optical noise.

For example, the light source unit 131 may irradiate light to the subject 200 at a predetermined incident angle θ according to control of the controller 140 such that optical noise having a blue wavelength only may be generated from the subject 200. Of course, optical noise having only a red or green wavelength other than a blue wavelength may be generated from the subject 200 by adjusting the incident angle θ of the light source unit 131 or the rotation angle with respect to the imaging unit 120.

With regard to optical noise of a blue wavelength, the optical noise shielding optical filter 161 may shield the optical noise of the blue wavelength, and thus, the imaging unit 120 may detect image information containing information on a surface defect of the subject 200.

On the other hand, the surface defect detecting apparatus of FIG. 2B may originally shield light having a wavelength range whereby optical noise is generated.

The surface defect detecting apparatus of FIG. 2B is configured such that a light shielding filter 365 is further installed on an optical path between a light source unit 331 and the subject 200 so as to originally shield light having a wavelength range whereby optical noise is generated from the subject 200.

In the surface defect detecting apparatus of FIG. 2B, the light shielding filter 365 is disposed on an optical path between a collimator lens 331-3 and the subject 200. However, the present invention is not limited thereto. Alternatively, the light shielding filter 365 may be disposed on an optical path between a light source 331-1 and the collimator lens 331-3.

In the surface defect detecting apparatus of FIG. 2B, the light source unit 331 may irradiate light whereby optical noise of the same wavelength is generated from the subject 200 at a predetermined angle θ according to control of the controller 140.

In this case, the light the light source unit 331, whereby optical noise having the same wavelength is generated, may be shielded by the light shielding filter 365. Thus, an imaging unit 320 may detect only image information containing information on a surface defect of the subject 200 without optical noise.

For example, when the light source unit 331 irradiates light onto the subject 200 at a rotation angle of the light source unit 331 with respect to the imaging unit 320 or at a predetermined incident angle θ at which optical noise having a blue wavelength only is generated from the subject 200 according to control of the controller 140, the light shielding filter 365 may shield light having a blue wavelength band.

Thus, since light whereby optical noise is generated is not originally irradiated onto a surface of the subject 200, optical noise is not generated from the surface of the subject 200 and the imaging unit 320 may detect only image information containing information on a surface defect of the subject 200.

In this case, the light shielding filter 365 is not limited to a filter for shielding light having a blue wavelength band. That is, the light shielding filter 365 may be a filter for shielding a wavelength of the light source unit 331, corresponding to a wavelength of optical noise, such as a red or green wavelength, according to the wavelength of the optical noise, such as a red or green wavelength, which is determined according to an incident angle θ of the light source unit 331 or a rotation angle of the light source unit 331 with respect to the imaging unit 320.

Alternatively, as shown in FIG. 2C, the surface defect detecting apparatus of FIG. 2C may include a light source unit including a light source 531-1 that itself generates mono color light.

When the light source unit shown in FIG. 2C includes the light source 531-1 of mono color light, the light source 531-1 emits mono color light having a different wavelength from a wavelength of optical noise, which is determined according to an incident angle θ of the light source unit and a rotation angle of the light source unit with respect to an imaging unit 520.

Thus, since light whereby optical noise is generated is not originally irradiated onto a surface of the subject 200, optical noise may not be generated from the surface of the subject 200 and the imaging unit 520 may detect only image information containing information on a surface defect of the subject 200.

In detail, when the light source unit irradiates light onto the subject 200 at a predetermined incident angle θ at which optical noise having only a blue wavelength is generated from the subject 200 according to control of the controller 140, the light source 531-1 of mono color light may emit mono color light having a different wavelength (e.g., a red or green wavelength) from a blue wavelength, which is determined according to an incident angle θ or a rotation angle of the light source unit with respect to the imaging unit 520.

As mono color light of a red or green wavelength is generated and irradiated onto the subject 200, optical noise of a blue wavelength is not originally generated from a surface of the subject 200. Thus, the imaging unit 520 may detect only image information containing information on a surface defect of the subject 200.

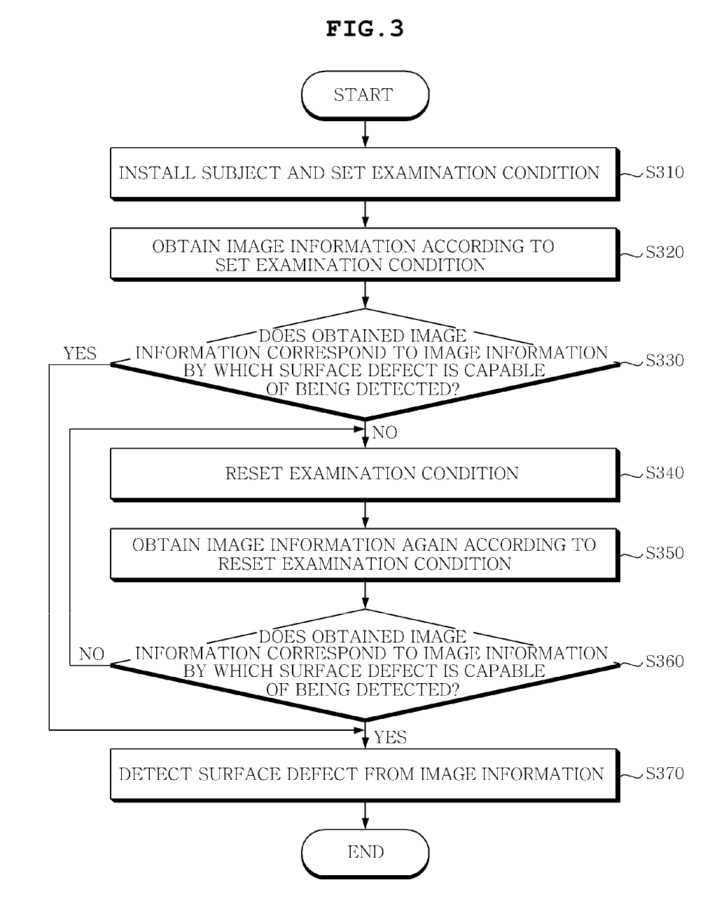

Since the surface defect detecting apparatus of FIG. 3 uses mono color light having a different wavelength from a wavelength of optical noise, which is determined according to an incident angle θ of the light source unit, the optical noise shielding optical filter 161 or the light shielding filter 365 is not required, mono color light may be transmitted through a collimator lens 531-2 and then may be irradiated directly onto the subject 200.

Unlike the surface defect detecting apparatuses of FIGS. 2A through 2C, the surface defect detecting apparatus of FIG. 2D does not use a lamp as a light source and uses as a laser such as a CO₂ laser, an excimer laser, or the like as a light source 731-1.

Since the surface defect detecting apparatus of FIG. 2D includes a laser as the light source 731-1, a light source unit may include a beam expander 731 for enlarging a mono wavelength of a laser beam emitted from the light source 731-1 and irradiating the laser beam onto the subject 200.

The beam expander 731 may include two lenses 731-2 and 731-3 whose focal point locations match each other or a prism in order to convert a flux of parallel rays emitted from the light source 731-1, such as laser beams, into a thick flux of parallel rays.

In this case, a wavelength of the laser beam emitted from the light source 731-1 corresponds to a mono light wavelength that is different from a wavelength of optical noise, which is determined according to an incident angle θ of the light source unit 531 or a rotation angle of the light source unit 531 with respect to an imaging unit 720. In addition, the laser beam having a mono color wavelength is irradiated onto the subject 200 through the beam expander 731.

Thus, since light whereby optical noise is generated is not originally irradiated onto a surface of the subject 200, optical noise is not generated from the surface of the subject 200 and the imaging unit 720 may detect only image information containing information on a surface defect of the subject 200.

In detail, when the laser beam emitted from the light source 731-1 is irradiated onto the subject 200 at a predetermined angle θ at which optical noise having a blue wavelength only is generated from the subject 200, according to control of the controller 140, the light source 731-1 may be configured to generate a laser beam having a different wavelength from a blue wavelength, such as a red or green wavelength.

As a laser beam such as a red or green color laser beam is irradiated onto the subject 200 through the beam expander 731, optical noise having a blue wavelength is not originally generated from a surface of the subject 200. Thus, the imaging unit 720 may detect only image information containing information on a surface defect of the subject 200.

Thus, the surface defect detecting apparatus of FIG. 2D does not require a polarization filter, the optical noise shielding optical filter 161, or the light shielding filter 365 and may irradiate a laser beam whereby optical noise is not originally generated onto an entire surface of the subject at a predetermined incident angle θ by using the beam expander 731.

Hereinafter, a method of controlling a surface defect detecting apparatus according to an embodiment of the present invention will be described with reference to FIGS. 3 through 8. FIG. 3 is a flowchart of a method of controlling a surface defect detecting apparatus, according to an embodiment of the present invention.

As shown in FIG. 3, in the method of controlling the surface defect detecting apparatus 100 according to the present embodiment, the subject 200 having a uniform grating pattern, such as a CMOS image sensor, a CCD image sensor, or the like is installed on an upper surface of the stage unit 110 and an examination condition for examining a surface defect of the subject 200 is set (S310).

In detail, in the method of controlling the surface defect detecting apparatus 100, the examination condition includes a condition for converting optical noise generated due to a repeated grating interval ‘d’ of the subject 200 into optical noise at the same frequency.

That is, the examination condition may include a condition for setting an incident angle θ at which optical noise at the same frequency is generated according to the repeated grating interval and a diffraction orders ‘m’, the repeated pattern gratings of the subject 200, and the like. Of course, the examination condition may include a rotation angle of the light source unit 131 with respect to the imaging unit 120.

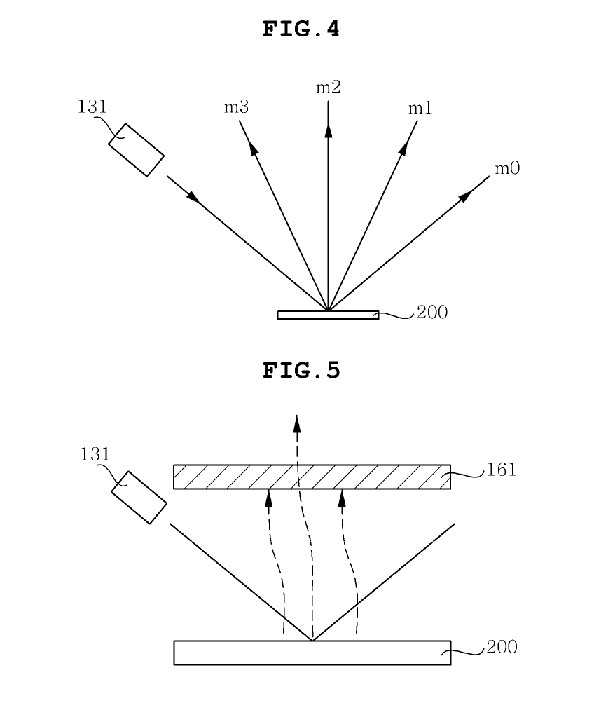

For example, light obtained by reflecting light emitted from the light source unit 131 off the subject 200 having the repeated grating interval ‘d’ may be detected to have the diffraction orders m, as shown in FIG. 4.

In this case, the diffraction orders ‘m’ corresponding to light beams emitted towards the imaging unit 120 may be set and then an incident angle θ may be set by using Equation 1 below according to the repeated grating interval ‘d’, the diffraction orders ‘m’, and a wavelength λ of light emitted from the light source unit 131.

n′ sin θ′−n sin θ=m(λ/d) (1)

(n′: refractive index of emitted-light region, θ′: emitting angle of emitted light, n: refractive index of irradiated light region, θ: incident angle of irradiated light, m: diffraction order of emitted light, λ: wavelength of emitted light, d: grating interval of the subject 200)

In Equation 1 above, since a refractive index of air is 1, n′=n=1. In addition, since θ′ corresponds to a direction toward the imaging unit 120 that is perpendicularly disposed above the subject 200, θ′=0.

When the incident angle θ of irradiated light is set, color of optical noise generated from the subject 200 may be determined according to the incident angle θ, as shown in FIG. 5. For example, when the grating interval ‘d’ of the subject 200 is 1.5 μm and the diffraction order m is 2, optical noise having the same color that is blue may be detected at an incident angle θ in the range of 35 to 40 degrees and optical noise having the same color that is red may be detected at an incident angle θ in the range of 58 to 63 degrees.

After the examination condition including a set value of the incident angle θ is set, the controller 140 performs surface defect examination of the subject 200 according to the set examination condition and obtains image information on a surface of the subject 200 according to the result of the surface defect examination (S320).

When the surface defect examination is performed on the surface of the subject 200 according to the examination condition including the set incident angle θ, background noise from the surface of the subject and noise due to a backlight effect as well as reflected examination light due to the surface defect are simultaneously generated from the subject 200.

In this case, noise may be generated at the same frequency due to the set incident angle θ, and thus, optical noise having the same color may be detected, as shown in FIG. 5.

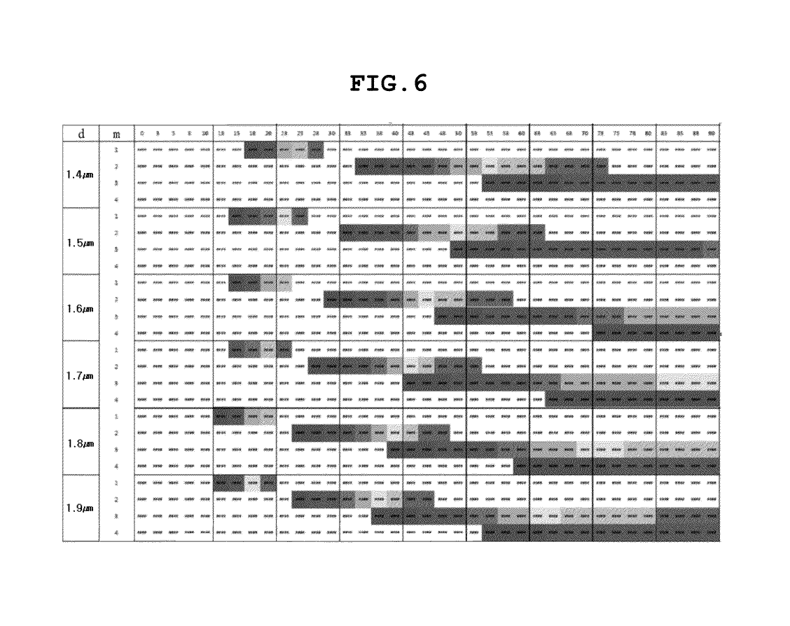

As shown in FIG. 6, the optical noise having the same color may be shielded by the optical noise shielding optical filter 161, only reflected light due to a surface defect is transmitted so as to be captured by the imaging unit 120, and image information on the surface of the subject 200 is obtained.

After the image information on the surface of the subject 200 is obtained, the controller 140 determines whether the image information obtained from the imaging unit 120 corresponds to image information by which a surface defect of the subject 200 is capable of being detected according to a user command or by automation (S330).

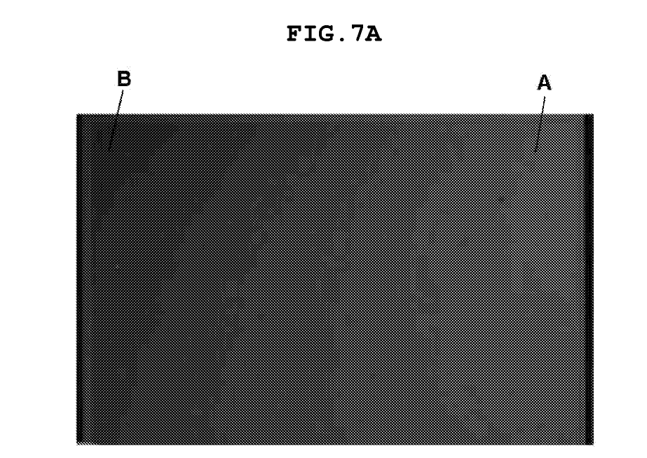

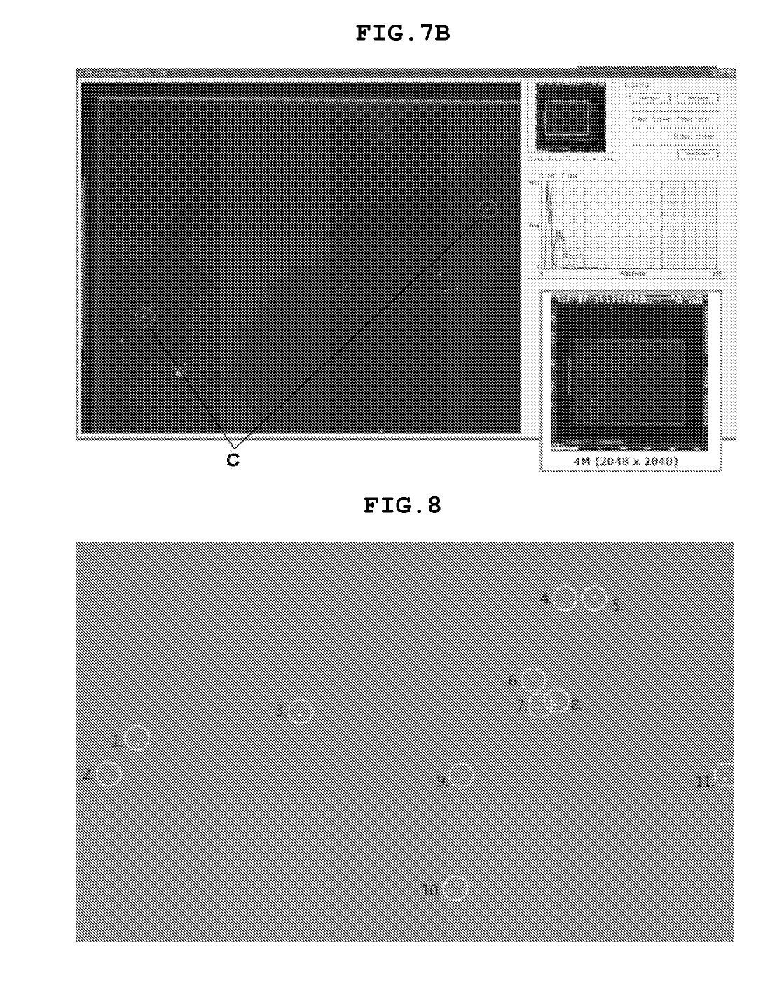

For example, when the image information obtained from the imaging unit 120 corresponds to defective image information that has a brightness difference between regions “A” and “B” of an image shown in FIG. 7A and by which a surface defect is not capable of being detected, the controller 140 determines that the image shown in FIG. 7A is a defective image and displays a defect via the display unit 150. In this case, the image shown in FIG. 7A is an example of an image that is detected by the imaging unit 120 without the optical noise shielding optical filter 161.

When an image is determined as a defective image, the controller 140 resets an examination condition by using the surface defect detecting apparatus 100 according to a user command or automatically (S340).

For example, in the setting of the examination condition (S310), the controller 140 resets the set incident angle θ to an angle at which optical noise has different color from in the case of the incident angle θ. That is, the controller 140 resets an incident angle θ or a rotation angle of the light source unit 131 with respect to the imaging unit 120 by changing a position and an angle of the light source unit 131 and irradiates light emitted from the light source unit 131 at the reset incident angle θ or the reset radiation angle.

Of course, the examination condition may be reset by changing the diffraction order ‘m’, the wavelength λ of light irradiated from the light source unit 131, and the like other than the incident angle θ of the light source unit 131 and the rotation angle of the light source unit 131.

After the examination condition is reset according to a user command or automatically, a surface of the subject 200 is examined according to the reset examination condition and image information on the surface of the subject 200 is obtained again (S350).

The controller 140 determines again whether the image information that is obtained again corresponds to the image information by which a surface defect of the subject 200 is capable of being detected (S360).

In this case, when it is determined that the image information that is obtained again from the imaging unit 120 corresponds to image information by which a surface defect is not capable of being detected, like the defective image shown in FIG. 7A, the controller 140 resets an examination condition (S340).

On the other hand, when it is determined that the image information that is obtained again corresponds to image information on an image by which a surface defect is capable of being detected, the controller 140 detects information on the surface defect from the image information that is obtained again (S370).

That is, as shown in FIG. 7B, if the image information that is obtained again from the imaging unit 120 corresponds to image information containing a surface defect of the subject 200, such as “C”, the controller 140 detects information on the surface defect from the image information that is obtained again.

Thus, the controller 140 displays the information on the surface defect of the subject 200 via the display unit 150. That is, as shown in FIG. 8, the controller 140 displays the information on the surface defect of the subject 200 by displaying a region where the surface defect of the subject 200 is detected together with a number via the display unit 150.

Thus, in the method of controlling the surface defect detecting apparatus 100, since optical noise generated from the subject 200, such as diffraction light is converted into optical noise at the same frequency having the same color according to an examination condition and is removed at one time by an optical noise shielding optical filter, only information on a surface defect of the subject 200 may be detected at a high resolution.

Thus, the method of controlling the surface defect detecting apparatus 100 may increase a resolution of an image without a reduction in contrast of the image and may detect information on a surface defect of the subject 200 so as to find a non-defective product of the subject 200.

The surface defect detecting apparatus according to the present invention may detect only image information containing a surface defect of a subject by shielding optical noise generated from the subject, and thus, may detect the surface defect of the subject at a high resolution.

The method of controlling the surface defect detecting apparatus according to the present invention may increase a resolution of an image without a reduction in contrast of the image and may detect information on a surface defect of the subject so as to find a non-defective product of the subject.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A surface defect detecting apparatus, comprising:
a stage unit having an upper surface on which a subject is disposed;
at least one light source unit that is moved according to an examination condition and irradiates examination light onto a surface of the subject;
an imaging unit that receives light emitted from the surface of the subject and captures an image of the surface of the subject;
a controller that is connected to the at least one light source unit and the imaging unit, sets the examination condition, controls an overall operation, and detects a surface defect of the subject by using the image captured by the imaging unit; and
a display unit displaying image information on the surface defect detected by the controller.

2. The surface defect detecting apparatus as set forth in claim 1, wherein the at least one light source includes a lamp light source, and a collimator lens for converting light emitted from the lamp light source into linear light.

3. The surface defect detecting apparatus as set forth in claim 1, further comprising at least one light shielding filter that is disposed on an optical path between the at least one light source unit and the subject and shields light of a wavelength range whereby optical noise is generated.

4. The surface defect detecting apparatus as set forth in claim 1, further comprising an optical noise shielding optical filter disposed on an optical path between the imaging unit and the subject.

5. The surface defect detecting apparatus as set forth in claim 4, wherein the optical noise shielding optical filter includes at least one of a band filter, a notch filter, and a dichroic.

6. The surface defect detecting apparatus as set forth in claim 1, wherein the at least one light source unit includes a mono color light source, and
wherein the light source emits light of a mono color wavelength that is differently set from a wavelength of optical noise generated from the surface of the subject.

7. The surface defect detecting apparatus as set forth in claim 6, wherein the light source includes a laser for emitting light of a mono color wavelength that is differently set from the optical noise generated from the surface of the subject; and a beam expander for enlarging the light emitted from the laser and irradiating the light onto the surface of the subject.

8. The surface defect detecting apparatus as set forth in claim 1, wherein the examination condition includes, as a condition for converting optical noise generated from the surface of the subject into optical noise at the same frequency, a condition about an incident angle θ of the examination light, which is set so as to convert the optical noise into optical noise at the same frequency according to a grating interval ‘d’ of a uniform grating pattern of the subject and a diffraction order ‘m’.

9. The surface defect detecting apparatus as set forth in claim 8, wherein the examination condition includes a rotation angle of the at least one light source unit with respect to the imaging unit.

10. A method of controlling a surface defect detecting apparatus including at least one of light source unit irradiating examination light onto a surface of a subject disposed on an upper surface of a stage unit, and an imaging unit receiving light emitted from the surface of the subject and capturing an image of the subject of the subject, the method comprising:
setting an examination condition for examining a surface defect;
obtaining image information on the surface of the subject by performing surface defect examination on the subject according to the examination condition;
determining whether the obtained image information corresponds to image information by which the surface defect of the subject is capable of being detected;
when it is determined that the obtained image information corresponds to defective image information by which a surface defect is not capable of being detected, resetting the examination condition;
obtaining image information on the surface of the subject again by performing surface defect examination again on the subject according to the reset examination condition;
determining again whether the image information that is obtained again corresponds to image information by which the surface defect of the subject is capable of being detected; and
when it is determined that the image information that is obtained again corresponds to the image information by which the surface defect of the subject is capable of being detected, detecting information on the surface defect from the image information that is obtained again.

11. The method as set forth in claim 10, wherein, in the setting of the examination condition, the examination condition includes a condition for converting optical noise generated from the surface of the subject into optical noise at the same frequency and includes a condition about an incident angle θ of the examination light, which is set so as to convert the optical noise into optical noise at the same frequency according to a grating interval ‘d’ of a uniform grating pattern of the subject and a diffraction order ‘m’.

12. The method as set forth in claim 11, wherein the examination condition includes a rotation angle of the at least one light source unit with respect to the imaging unit.

13. The method as set forth in claim 11, wherein the incident angle θ satisfies a relationship of n′ sin θ′=n sin θ=m(λ/d) (n′: refractive index of emitted-light region, θ′: emitting angle of emitted light, n: refractive index of irradiated light region, θ: incident angle of irradiated light, m: diffraction order of emitted light, λ: wavelength of emitted light, d: grating interval of the subject).

14. The method as set forth in claim 11, wherein the obtaining of the image information further includes shielding optical noise that is converted at the same frequency by using an optical noise shielding optical filter.

15. The method as set forth in claim 11, wherein, in the resetting of the examination condition, at least one of a diffraction order ‘m’, a wavelength of the examination light ‘λ’, and an incident angle θ of the examination light is reset with respect to a grating interval ‘d’ of a uniform grating pattern of the subject.

16. The method as set forth in claim 12, wherein the resetting of the examination condition further includes resetting a rotation angle of the at least one light source unit with respect to the imaging unit.

17. The method as set forth in claim 10, wherein the detecting of the information on the surface defect further includes displaying information on a region where the surface defect of the subject is detected together with a number.
